(19) United States
(12) Patent Application Publication
(10) Pub. No.: US 2026/0057386 A1
(43) Pub. Date: Feb. 26, 2026

(54) ANOMALY DETECTION AND TRANSACTION INTEGRITY PLATFORM

(71) Applicant: ADP, Inc., Roseland, NJ (US)

(72) Inventor: Ramsay Cole, Roseland, NJ (US)

(73) Assignee: ADP, Inc., Roseland, NJ (US)

(21) Appl. No.: 18/811,435

(22) Filed: Aug. 21, 2024

(51) Int. Cl. G06Q 20/40

(52) U.S. Cl. CPC G06Q 20/4016

(57) ABSTRACT

An anomaly detection and transaction integrity platform is provided. A system receives data for profiles linked with accounts of an entity. The data indicates first historical data of first interactions of accounts with a first computing system, and second historical data indicative of second interactions of accounts with a second computing system. The system generates, using one or more models trained with machine learning, a metric indicative of a pattern of transactions. The system determines, based on a comparison of a value of the metric with a threshold, to invoke an automated process via the payroll processing system to modify at least one of the metric or the threshold. The system selects, using the one or more models, an action to execute via the automated process that modifies the metric or the threshold. The system commands, via the automated process, the payroll processing system to execute the action.

### TECHNICAL FIELD

This application is generally related to computing technology, and particularly to analysis and reduction of system processing anomalies and generation of actions to improve transaction integrity.

### BACKGROUND

Advancements in data processing technology have transformed numerous industries, facilitating automated decision-making, predictive analytics, and efficient data handling. These capabilities significantly enhance operational efficiency, particularly in managing complex data interactions and transactional workflows within digital environments.

### SUMMARY

When utilizing automated processing functions to implement different transactions for various accounts of entities, such as corporations or organizations, it can be technically challenging to maintain the integrity of the transactions in view of variability in transactions and the accounts. Failing to detect erroneous transactions in real-time can strain computational resources and increase the processing time, thereby hindering the system energy efficiency, while also compromising the system's reliability. Aspects of technical solutions disclosed herein can overcome these, and other, challenges by leveraging artificial intelligence (AI) models trained on historical data, such as payroll transactions and accounts data, to establish expected transactional patterns and generate account specific metrics indicative of the patterns. By monitoring transactional data and comparing the account metrics with thresholds for the given patterns, the technology can identify deviations associated with the accounts that can be indicative of errors or anomalies. Using the metrics, the thresholds and the AI functionality, the technical solutions can select and call for corrective actions to be taken by automated processing functions of the transaction processing system. In doing so, the technical solutions can detect transactions indicative of process errors or malicious acts, such as fraud, in real-time. In doing so, the technical solutions can conserve computational resources, decrease the processing time, while improving the energy efficiency and the reliability of the system.

Aspects of the technical solutions disclosed herein are directed to a system. The one or more processors can be coupled with memory. The one or more processors can be configured to receive, from a payroll processing system, data for each of a plurality of profiles linked with one or more accounts of an entity, the data indicative of a plurality of instances of first historical data and second historical data. The first historical data can be indicative of one or more first interactions of the one or more accounts with a first computing system. The second historical data can be indicative of one or more second interactions of the one or more accounts with a second computing system. The one or more processors can be configured to generate, using one or more models trained with machine learning on the plurality of instances of the first historical data and the second historical data, a metric. The metric can be indicative of a pattern of transactions, the metric corresponding to an account of the entity linked to a profile. The one or more processors can be configured to determine, based on a comparison of a value of the metric with a threshold, to invoke an automated process via the payroll processing system to modify at least one of the metric or the threshold. The one or more processors can be configured to select, using the one or more models, an action to execute via the automated process that is configured to modify the metric or the threshold. The one or more processors can be configured to command, via the automated process, the payroll processing system to execute the action to modify the metric or the threshold.

The one or more processors can be configured to identify that the account corresponds to a group of accounts associated with a constraint for the pattern of transactions. The one or more processors can determine that the threshold does not satisfy the constraint for the group of accounts. The one or more processors can be configured to select, based on the threshold not satisfying the constraint, the action to modify the threshold.

The one or more processors can be configured to identify that the account corresponds to a group of accounts associated with a constraint for the pattern of transactions and determine that the threshold satisfies the constraint for the group of accounts. The one or more processors can be configured to select, based on the threshold satisfying the constraint, the action to modify the metric.

The one or more processors can be configured to generate, based on the first historical data, one or more first features indicative of the one or more first interactions involving providing of resources of the entity to the account. The one or more processors can be configured to generate, using the one or more models receiving input including the one or more first features, the metric. The one or more processors can be configured to generate, based on the second historical data, one or more second features indicative of the one or more second interactions associated with information generated by a user associated with the account, the information used to provide a resource of the entity to the account. The one or more processors can be configured to generate, using the one or more models receiving input including the one or more second features, the metric.

The one or more processors can be configured to command, via the automated process, the payroll processing system to execute a second action to modify one or more operations of the first computing system with respect to the profile. The one or more processors can be configured to command, via the automated process, the payroll processing system to execute a third action to modify one or more operations of the second computing system with respect to the profile.

The first interactions can each include one or more parameters indicative of one or more corresponding payroll transactions executed by the entity on behalf of the one or more accounts. The second interactions can each include one or more parameters indicative of one or more actions associated with the one or more accounts. The one or more actions can impact one or more payroll transactions indicated by parameters of the first interactions. The automated process can correspond to at least one of a notification from the payroll processing system, a restriction on communication with the first computing system, or a restriction on communication with the second computing system. The action can correspond to detection of a difference between interactions linked with the profile at the payroll processing system and interactions linked with the profile at the first computing system or the second computing system.

Aspects of the technical solutions disclosed herein are directed to a method. The method can include receiving, by a processor from a payroll processing system, data for each of a plurality of profiles linked with one or more accounts of an entity. The data can be indicative of a plurality of instances of first historical data and second historical data. The first historical data can be indicative of one or more first interactions of the one or more accounts with a first computing system and the second historical data indicative of one or more second interactions of the one or more accounts with a second computing system. The method can include generating, by the processor using one or more models trained with machine learning on the plurality of instances of the first historical data and the second historical data, a metric indicative of a pattern of transactions. The metric can correspond to an account of the entity linked with a profile. The method can include determining, by the processor and based on a comparison of a value of the metric with a threshold of the profile, to invoke an automated process via the payroll processing system to modify at least one of the metric or the threshold. The method can include selecting, by the processor using the one or more models, an action to execute via the automated process that is configured to modify the metric or the threshold. The method can include commanding, by the processor via the automated process, the payroll processing system to execute the action to modify the metric or the threshold.

The method can include identifying, by the processor, that the account corresponds to a group of accounts associated with a constraint for the pattern of transactions. The method can include determining, by the processor, that the threshold does not satisfy the constraint for the group of accounts. The method can include selecting, based on the threshold not satisfying the constraint, the action to modify the threshold with respect to the profile.

The method can include identifying, by the processor, that the account corresponds to a group of accounts associated with a constraint for the pattern of transactions. The method can include determining, by the processor, that the threshold satisfies the constraint for the group of accounts. The method can include selecting, by the processor, based on the threshold satisfying the constraint, the action to modify the metric with respect to the profile.

The method can include generating, by the processor and based on the first historical data, one or more first features indicative of the one or more first interactions. The method can include generating, by the processor using the one or more models receiving input including the one or more first features, the metric. The method can include generating, by the processor and based on the second historical data, one or more second features indicative of the one or more second interactions. The method can include generating, by the processor using the one or more models receiving input including the one or more second features, the metric.

The method can include commanding, by the processor via the automated process, the payroll processing system to execute a second action to modify one or more operations of the first computing system with respect to the profile. The method can include commanding, by the processor via the automated process, the payroll processing system to execute a third action to modify one or more operations of the second computing system with respect to the profile. The first interactions can each include one or more parameters indicative of one or more corresponding payroll transactions linked with the profile and the second interactions can each include one or more parameters indicative of one or more actions corresponding to management of resources of the entity.

Aspects of the technical solutions are directed to a non-transitory computer readable medium including one or more instructions stored thereon and executable by a processor. When executed, the one or more instructions can cause the processor to receive, by a processor from a payroll processing system, data for each of a plurality of profiles linked with one or more accounts of an entity. The data can be indicative of a plurality of instances of first historical data and second historical data. The first historical data can be indicative of one or more first interactions of the one or more accounts with a first computing system and the second historical data can be indicative of one or more second interactions of the one or more accounts with a second computing system. When executed, the one or more instructions can cause the processor to generate, by the processor using one or more models trained with machine learning on the plurality of instances of the first historical data and the second historical data, a metric indicative of a pattern of transactions, the metric corresponding to an account of the entity linked to a profile. When executed, the one or more instructions can cause the processor to determine, by the processor and based on a comparison of a value of the metric with a threshold, to invoke an automated process via the payroll processing system to modify the metric. When executed, the one or more instructions can cause the processor to select, by the processor using the one or more models, an action to execute via the automated process that is configured to modify the metric. When executed, the one or more instructions can cause the processor to command, by the processor via the automated process, the payroll processing system to execute the action to modify the metric with respect to the profile.

### BRIEF DESCRIPTION OF THE DRAWINGS

Aspects of the technical solutions are described in the detailed description which follows, in reference to the noted plurality of drawings by way of non-limiting examples of exemplary embodiments of the technical solutions described herein.

FIG. 1 depicts an example of a system for providing AI-based anomaly detection and selection of corrective actions to improve transaction integrity.

FIG. 2 depicts an architecture of a computing system implemented in embodiments of the technical solutions described herein.

FIG. 3 depicts a cloud computing environment 300 in accordance with aspects of the technical solutions described herein.

FIG. 4 depicts an example of a transaction processor providing different automated processing functions for processing transactions and actions.

FIG. 5 depicts a flow diagram of a method 500 for providing AI-based anomaly detection and selection of corrective actions to improve transaction integrity.

### DETAILED DESCRIPTION

Following below are more detailed descriptions of various concepts related to, and implementations of, methods, apparatuses, and systems provide anomaly detection and corrective actions to improve transaction integrity. The various concepts introduced above and discussed in greater detail below can be implemented in any of numerous ways.

Automated transaction processing can be an important aspect of modern business operations, allowing entities such as corporations and organizations to streamline their asset transactions. These systems can include processing functions that automate the execution of various types of transactions across diverse accounts, allowing for automated management of complex account-specific interactions in which speed, accuracy, and reliability are important. However, the complexity of handling diverse transactional workflows can introduce challenges in maintaining transactional integrity and preempting errors before they impact operational efficiency. Real-time detection of erroneous transactions or processing errors can be important in mitigating risks associated with processing discrepancies and system reliability issues, creating a desire for solutions that can adapt to dynamic transactional environments and ensure robust operational frameworks.

When utilizing automated processing to implement transactions across different accounts, such as those within corporations or organizations, maintaining transactional integrity can be a challenge due to the variability inherent in transaction types and account behaviors. Detecting erroneous transactions in real-time is particularly challenging, as delays can trigger additional and often undesirable processing steps, strain computational resources and compromise system reliability. This strain can, not only impact the energy efficiency of the system, but it also can increase the risk of transaction discrepancies and operational disruptions. The complexity of handling diverse transactional workflows within digital environments can further exacerbate these challenges, triggering a preference for robust mechanisms to preempt processing errors before they are transacted.

The technical solutions of this disclosure overcome these, and other, challenges by employing advanced AI models trained on historical data to identify transactional patterns, generate account specific metrics corresponding to the patterns and take corrective actions when metrics fall outside the pattern thresholds. The technical solutions can utilize models that establish baseline transactional patterns, allowing for systematic monitoring and detection of deviations indicative of potential errors or anomalies. By comparing the account-specific metrics with transactional pattern thresholds during the transactional processing, the technical solutions can timely identify and mitigate risks in real-time, thereby improving the system reliability and maintaining transactional integrity. In doing so, the technical solutions can conserve computational resources and improve the system energy efficiency, while also providing smoother operational workflows and improving transactional reliability of the system.

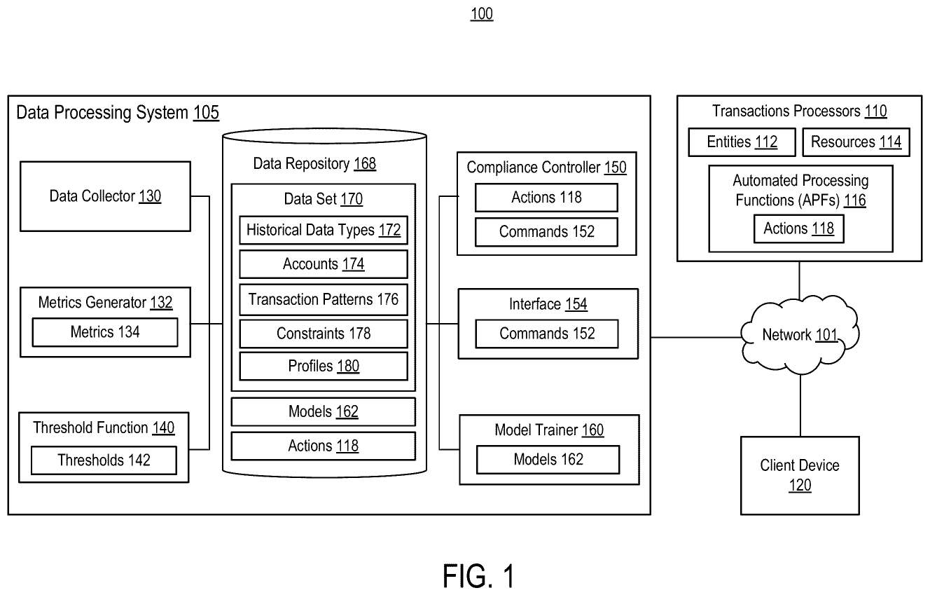

FIG. 1 depicts an example system 100 for providing AI-based anomaly detection and selection of corrective actions to improve transaction integrity. The system 100 can include a data processing system 105. The data processing system 105 can include or be processed using one or more processors (e.g., 215) coupled with memory (e.g., 225). The system 100 can include interface with, access or communicate with (e.g., via network 101), or otherwise utilize one or more of a transactions processors 110. Transactions processors 110 can be provided on the same or different computational platforms (e.g., computing servers or cloud-based environments) as those of the data processing system 105. Data processing system 105 can also communicate (e.g., via a network 101) with one or more client devices 120 seeking to utilize the functionalities of the data processing system 105 or transactions processors 110.

The data processing system 105 can include, access, or otherwise utilize one or more data collectors 130 that are designed, constructed and operational to receive, request, access, or otherwise obtain data for anomaly detection or transaction integrity by the data processing system 105. The data processing system 105 can include, access or otherwise utilize one or more metrics generators 132 designed, constructed or operational to determine metrics 134 associated with transaction patterns 176 corresponding to accounts 174 associated with individual profiles 180. The data processing system 105 can include, access or otherwise utilize one or more threshold functions 140 designed, constructed and operational to determine thresholds 142 for accounts 174 associated with individual profiles 180 and compare metrics 134 with the thresholds 142. The data processing system 105 can include, access or otherwise utilize one or more compliance controllers 150 designed, constructed and operational to determine, based on the comparison of the metric 134 with the threshold 142, to invoke automated processing functions 116 and implement selected actions 118 based on issued commands 152 to the automated processing functions 116. The data processing system 105 can include, access or otherwise utilize one or more interfaces 154 to communicate the commands 152 to the transactions processors 110 (e.g., via a network 101) to trigger the implementations of the actions 118. The data processing system 105 can include, access or otherwise utilize one or more model trainers 160 designed, constructed and operational to train models 162 using machine learning, obtain feedback associated with performance of the models, and update the models using machine learning and based on the feedback.

The data processing system 105 can include a data repository 168. Various components of the data processing system 105 (e.g., metrics generator 132, threshold function 140, compliance controller 150 or model trainer 160) can interface with or access the data repository 168 to access any data in the data set 170. The data set 170 can include one or more of historical data types 172, including payroll transaction data, such as pay stub information, tax deductions, 401K or IRA contributions, or medical or other benefit transaction data, as well as user account behavior data, such as employee access card data with access timing, time entries or clock timing, overtime or vacation entries, travel data, facility usage or other behavior related data. The repository 168 can include data on one or more accounts 174, transaction patterns 176, constraints 178 and profiles 180. Data repository 168 can store one or more models 162 and actions 118 that can be taken or implemented by transactions processor 110.

The data processing system 105 can include, or be communicatively coupled with (e.g., via a network 101), at least one logic device such as transactions processors 110. The transactions processors 110 can be, include, or be executed on, a computing device having a processor to implement automated processing functions 116 to implement actions 118 commanded, called or triggered by the compliance controller 150 (e.g., via a network 101). The transactions processors 110 can include, be executed on, or utilize, one or more computation resources, servers, processors or memories. The transactions processors 110 can facilitate communications between the data processing system 105, the data repository 168, or the client device via the network 101. The transactions processors 110 can be part of or included the data processing system 105. The transactions processors 110 can be remote from the data processing system 105.

The transactions processors 110 can include information or data on entities 112. Entities 112 can include corporations or organizations on behalf of whom automated processing functions 116 can be executed with respect to the accounts or profiles 180 of employees or users associated with such entities 112. Transactions processors 110 can execute various types and forms of transactions or processes associated with payroll, human resource or other transactional activities based on characteristics, demands or rules associated with, or specific to the entities 112. Transactions processors 110 can execute transactions or processes configured or tailored (e.g., via transaction parameters 176) for various internal sections, groups or departments of such entities, or individual employees associated with such entity's accounts 174.

Transactions processor 110 can utilize automated processing functions 116, also referred to as APFs 116, to provide, allocate, transfer, assign, transact or otherwise manage any resources 114 with respect to any accounts 174 associated with entities 112. Automated processing functions 116 can include, for example, any payroll transaction processing functions, such as functions for processing transactions for pay stubs, employee salaries, bonuses, or medical or other benefits. Automated processing functions 116 can include transactions for processing time entries, employee clock (e.g., start and stop work time), employee facility access card activity monitoring functions or any other functions associated with behavior or actions of users (e.g., employees) associated with the accounts 174 or profiles 180. APFs 116 can include transactions or applications for financial planning, such as AI-model based financial planning using payroll and demographic data of users (e.g., employees) associated with accounts 174. APFs 116 can include e-commerce recommendation functions for providing e-commerce recommendations for various accounts 174, based on the account related data and using AI-modelling. APFs 116 can include functions for providing an educational platform personalized for particular accounts 174 or user profiles (e.g., training or education materials or lessons generated or selected based on data associated with an account 174 or profile 180). APFs 116 can include functions for providing value assessments and predictions for assets (e.g., pieces of art or other property) based on historical data or transaction patterns.

The transactions processors 110 can perform one or more functions relating to payroll for the entity 112. For example, the transactions processors 110 can perform payroll processing functions, human resource management functions, time and attendance tracking functions, benefits administration functions, talent management functions, or analytics and reporting functions, among others. The transactions processors 110 can generate data relating to the payroll functions it performs and store the data in the data repository as historical data types 172.

Resources 114 transacted by the transactions processors 110 can include any values or parameters transacted by the automated processing functions 116. Resources 114 can include values associated with payroll transactions or human resources processing transactions. Resources 114 can include or correspond to monetary currencies, such as salary payments, bonuses, and deductions. Additionally, resources 114 can encompass non-monetary items such as vacation days, sick leave balances, and employee benefits. Resources 114 can include digital assets like access permissions, software licenses, document or data access, equipment allocations, compliance metrics, performance evaluations, and training completions.

Various components of the data processing system 105 (e.g., the data collector 130, the metrics generator 132, the threshold function 140, the compliance controller 150, the model trainer 160, or the data repository 168) can communicate with each other, share each other's functionalities and data in order to implement or perform functions or operations. For instance, each subcomponent can be located on a separate server or a computing device, or on one or more subcomponents located on the same server or a same cloud-based service. For example, each subcomponent of the data processing system 105 (e.g., 130, 132, 140, 150, 154, 160 or 168) can correspond to, or utilize one or more same or different processors 215. In some aspects, one or more subcomponents of the data processing system 105 can operate or execute on the client device 120. For example, operations of the data processing system 105 can operate on or are performed by an application (e.g., software application, such as a web browser or an application for accessing and utilizing features of the system 100 via a user interface) operating on the client device 120.

The client device 120 can include any computing device that can be used by a client associated with one or more accounts 172 or entity 112. The client device 120 can be used by a user for processing resources 114 using a transactions processor 110 or using operations of data processing system 105. The client device 120 can access and utilize the functionalities associated with the data collector 130, the metrics generator 132, the threshold function 140, the compliance controller 150, the model trainer 160, the data repository 168 or user interface 154. The client device can include, execute or provide an interface 154 on the client device 120 to allow the users of the client device 120 to access and operate functionalities of the data processing system 105. For example, the client device 120 can execute an application to perform some or all of the functionalities of the data collector 130, or the client device includes the data collector 130, using an interface 154 of the client device 120. In some aspects of the technical solutions described herein, the client device 120 includes one or more subcomponents of the data processing system 105, such as one or more of the data collector 130, the metrics generator 132, the threshold function 140, the compliance controller 150, the model trainer 160, or the data repository 168.

The client device 120 is or includes any computing device such as a laptop, a desktop computer, a smart phone, a tablet, etc. A user of the client device 120 may operate, display, or otherwise execute an application (e.g., a web browser or one or more agents of the automated processing functions 116 or a data processing system 105) via the client device 120. The client device 120 can include, or be coupled with, storage or memory (e.g., 225). The client device 120 can be operated by a user associated with an organization to perform various tasks associated with the organization. The client device 120 can execute one or more applications. The application can include any platform for performing the various tasks associated with the organization, such as low-code platform, no-code platform, software-as-a-service platform (SaaS), web application, web browser, desktop application, among others. In some aspects of the technical solutions described herein, the application is or includes an electronic transaction system for maintaining a data set to perform a transaction.

The transactions processors 110 can perform one or more functions relating to payroll for an entity 112. The entity 112 can be includes an individual, such as an employee of an organization as described herein, or a grouping of people, such as an organization, corporation, or educational institution. The transactions processors 110 can maintain information about the entity 112. The information can include historical data types 172 or any other data, such as name, address, social security number, salary, personally identifying information, demographic information, familial information, tax information, benefits information, or other such information. The entity 112 can have one or more geographic locations. For example, the transactions processors 110 can be an external computing system maintaining a data repository of the average salary the average salary for employees of a specific entity. The transactions processors 110 can store one or more types of data in the data repository 168.

The transactions processors 110 can generate one or more profiles 180 corresponding to the one or more accounts 174. A profile 180 can include any information indicative of a particular individual associated with an account 174 (e.g., an employee) or a group of individuals associated with a group of accounts 174. For instance, profile 180 can include any information, such as any historical data types 172, including confidential data, payroll data, personal behavior data, for any one or more individuals associated with one or more accounts 174. A profile 180 can be a profile of a particular employee account 174 including any historical data type 174 for that account. For instance, a profile 180 can include payroll processing information, parameters or statistics, associated with paycheck processing, tax deductions, processing of IRA or 401k contributions, medical or other benefits processing or any other compensation-based data of an employee. Profile 180 can include any behavior-indicative data, such as timecard data (e.g., when did an employee start and end his workday), facility access card data (e.g., when did employee enter or exit a premise or a site), when did the employee associated with an account 174 claim or seek personal time off or vacation. Profile 180 can be associated with multiple accounts 174, such as a profile for accounts of employees of a particular group (e.g., an engineering department, a management department, or a profile of part-time employees, temporary employees or night-shift employees). Profile 180 can be associated with individual accounts of individual employees. The transactions processors 110 can generate a profile 180 for each employee or group of employees of the entity 112, which the data processing system 105 can utilize to generate transaction patterns 176 for the accounts associated with the profiles 180 (e.g., generating transaction patterns 176 based on the profiles).

The network 101 can be a wireless or wired connection for enabling the data processing system 105 to store, transmit, receive, or display information to identify, extract, and map a data set from a first type to a second type. The data processing system 105 can communicate with internal subcomponents (described herein), or external components (e.g., the transactions processors 110 or the client device 120, among others) via the network 101. The data processing system 105 can, for example, store data about the system in the data repository 168. The data processing system 105 can, for example, receive the data set 170 transmitted from the data repository 168. The network can include a hardwired connection (e.g., copper wire or fiber optics) or a wireless connection (e.g., wide area network (WAN), controller area network (CAN), local area network (LAN), or personal area network (PAN)). For example, the network 101 can include Wi-Fi, Bluetooth, BLE, or other communication protocols for transferring over networks as described herein.

The data processing system 105 can include a data repository 168. The data repository 168 is any memory, storage, or cache for storing information or data structures of the system 100. The data repository 168 can include a non-transitory computer-readable medium. The data repository 168 allows data set 170 to be accessed by any components of the system 100, such as by communication methods described herein. The data repository 168 contains at least the data set 170, models 162, and actions 180. The data set 170 can include a plurality of historical data types 172, accounts 174, transaction patterns 176, constraints 178 and profiles 180, among others. The information in the data repository 168 can be stored in any kind of memory, such as a cloud or hard drive. The data repository 168 can include or utilize, for example, random access memory (RAM), dynamic random-access memory (DRAM), static random-access memory (SRAM), error correcting code (ECC), read only memory (ROM), programmable read only memory (PROM), or electrically erasable read only memory (EEPROM). The information or data structures (e.g., tables, lists, or spreadsheets) contained within the data repository 168 can be dynamic and change periodically (e.g., daily or every millisecond); via information from the server (e.g., through batch processing, real-time streaming, webhooks, scheduled jobs, incremental updates, database triggers, API requests, or version control systems, among others), via an input from a user (e.g., a user operating the client device 120), via information from the data repository 168, or the client device 120, transmitted through the network 101, via inputs from subcomponents of the data processing system 105, (the data collector 130, the metrics generator 132, the threshold function 140, the compliance controller, the model trainer 160, the data set 170, the models 162, or the actions 180) or via an external update to the system 100. For example, the models 162 within the data repository 168 change or are updated responsive to an indication from the model trainer 160.

The data repository 168 maintains the data set 170, the models 162, or the actions 180. The data set 170 (hereinafter referred to as data 170 or data sets 170 can include a plurality of values. The data set 170 can be stored in the data repository 168 or the data repository 168. The values can be alpha-numeric. In some cases, the values are displayable on a screen, such as that of the client device 120, or the data processing system 105. For example, the data set 170 can include strings such as “First Name” or “Earnings” along with values, such as “130,000” or “0.60.” The data set 170 can include auditory values, such as a sound or a vocal recording. The data set 170 can include colored or color coded-values. The data set 170 can include time-related values, such as a current time, elapsed time, or clock-in time, among others. The data set 170 can include images. The values of the data set 170 can include any combination of values. For example, a first value of the data set 170 includes an image and a string, and a second value of the data set 170 includes an auditory value. The values of the data set 170 can relate to each other. The data set 170 can be associated with a resource utilization of a location, role, or entity.

The data set 170 can include different attributes, such as file type, structure type, number of entities within the structure, nodes for the entities within the structure, or other such attributes. The data set 170 are included in, denoted by, or transmitted as an electronic file type. Examples of electronic file types include comma separated values (CSV), excel files (XLS or XLSM), or data interchange format (DIF), JavaScript Object Notation (JSON), among others. The data set 170 can be associated with or stored as a file type. The file determines or relates to data structures associated with the data set 170. In some technical solutions described herein, the data set 170 are encrypted by the data repository 168, such as by Advanced Encryption Standard (AES), Rivest-Shamir-Adleman (RSA), or another encryption standard. The data set 170 can be unencrypted by the transactions processors 110, or by another system enabled for access to the data set 170, such as the data processing system 105. In some aspects of the technical solutions described herein, one or more client devices requests access to the data set 170 or requests data set 170 itself from the transactions processors 110 via the data processing system 105 or through another computing system or the client device 120 directly. The data set 170 can be received from a client device 120 associated with the entity 112.

The data set 170 can include any number of historical data types 172. A first historical data type 172 can include a type of data corresponding to compensation or resources 114 transferred or transacted from an entity 112 to one or more accounts 174. The first historical data type 172a can be accessible for review to entity 112 and to the account 174 For instance, a first historical data type 172a can include data on salary, wages, bonuses, overtime pay, commissions, benefits and perks (e.g., health insurance coverage, retirement contributions, stock options, or wellness program participation, among others), payroll deductions (e.g., federal, state, or local taxes, social security contributions, healthcare contributions (e.g., Medicare contributions), or retirement plan contributions, among others). Such a first historical data type 172 can include variable pay factors (e.g., performance-based bonuses, profit sharing distributions, or incentivized compensation, among others), or information on payroll frequency (e.g., monthly, bi-weekly, or weekly, among others), among others. The first historical data type 172 can include or be generated along with a payroll data for employers within the entity, including: employee compensation (e.g., total payroll expenses, salary distributions, bonus allocations, or benefits contributions, among others), payroll expenses (e.g., payroll taxes, social security contributions, or healthcare contributions (e.g., Medicare contributions)), compensation structure (e.g., compensation by job role, pay equity analysis, or variable pay distribution, among others), benefits analysis (e.g., cost of employee benefits, utilization rates for health insurance, or retirement plan participation, among others), or turnover metrics (e.g., employee retention rates, reasons for turnover, or cost of employee turnover).

Historical data types 172 can include a second historical data type 172b that can correspond to behavior-tracking or behavior related data of the users or individuals associated with the accounts 174. The second historical data type 172b can include or correspond data (e.g., values or parameters) indicative of, or associated with, information generated by a user associated with the account 174, where the information can used to determine, compute or provide an amount of a resource 114 by the entity 112 to the account 174. For instance, the second historical data type can include behavior-tracking data for individuals associated with accounts 174, such as timecard data (e.g., entries of time of access to the workplace), clock time (e.g., data indicating start and stop of work time for an employee), or login activity (e.g., records of user login and logout times on a company's systems). This type of data can be utilized to assess work patterns and productivity levels, which can, in turn, be used to determine or transact resource allocation or employee evaluations. The second historical data type 172b can include transaction histories, detailing the frequency, timing, and amounts of transactions conducted by the user, providing insight into spending behaviors and financial stability. Behavior-tracking data can include location tracking (e.g., GPS data of work-related travel), which can help in verifying the geographical distribution of work activities or in monitoring compliance with travel policies.

The data processing system 105 can include a data collector 130 is designed, constructed, and operational to receive, identify, synchronize, or obtain the data set 170 or components of the data set 170 from the data repository 168. The data collector 130 include any combination of hardware and software for collecting, storing, processing, identifying, synchronizing, or receiving information or the data set 170 or subcomponents of the data set from one or more sources (e.g., the transactions processors 110). The data collector 130 can receive data based on a time interval or responsive to a condition or an event. The data collector 130 can make a request for data responsive to a condition, event or other trigger. For example, the data collector 130 can request data on a periodic basis. The data collector can request data responsive a determination or a transaction processed by an APF 116 with respect to an account 174.

Account 174 can include any digital representation of data or actions corresponds to a one or more individuals or users. Account 174 can be an account associated with a profile 180 and an entity 112, such as a corporation, to serve as a digital identity through which various transactions and interactions are processed on behalf of the account holder, often an employee. Account 174 can allow for automated processing functions 116 to process transactions such as payroll, human resources, and other administration related transactions and processes. For instance, an account 174 can include or store confidential data of an individual, such as a social security number, salary details, and employment history. Account 174 can include access credentials like usernames and passwords, which facilitate secure login to the company's internal systems. Other components of the account 174 may include benefits enrollment information, performance review records, and time-off requests, all of which can be integral to managing the employee's relationship with the entity 112 through the system 100.

Transaction patterns 176 can include any functions, parameters or numerical representations of recurring behaviors and sequences related to transactions conducted in connection with one or more accounts 174. Transaction patterns 174 can include numerical representations (e.g., functions) representing patterns associated with a group of accounts 174, such as accounts of an entity 112, accounts of a plurality of entities 112, accounts of a department within an entity 112, accounts of a plurality of particular departments (e.g., engineering departments, research and development departments or management group) across a plurality of entities 112, or any other grouping. Transaction patterns 174 can be used to create a range of expected behaviors that can be used to identify anomalies or inconsistencies.

Transaction patterns 176 can include tolerance ranges whose edges can be marked by thresholds 142. The thresholds 142 can include numerical values at the end of tolerance range of a transaction pattern 176, indicating a point up to which values may be considered a norm and beyond which values can be considered anomalies. The thresholds 142 can be established such that they indicate the edges of the tolerance range (e.g., the norm) of a transaction pattern 176. The thresholds 142 can be established or determined based on a variance of the data establishing a mean or a median value of the transaction pattern 176. For instance, thresholds 142 can be established at any variance or standard deviation point away from the mean or median value of the transaction pattern 176 (e.g., or a function of the transaction pattern), such as at any of: 1, 1.5, 1.8, 2.0, 2.5, 3.0 or more than 3 standard deviations or variances from the mean, median or average value of the transaction pattern 174. A transaction pattern 176 can have a plurality of different thresholds 142, such as when a transaction pattern 176 is a function, thereby establishing a function of thresholds 142 whose value can be determined for any point of the function.

Transaction patterns 176 can encompass a wide range of activities, such as transaction habits, periodic variations, vacation patterns, overtime patterns, purchasing habits, payment frequencies, or preferred transaction methods. For example, an employee's transaction pattern can include regular payroll deposits on specific dates or for specific amounts, a particular range of monthly deductions for benefits, and particular periodic expense reimbursements. Transaction patterns 176 can reveal insights into employee behaviors, such as, work habits, timing of vacations, timing of overtime, frequent purchases of specific types of office supplies or regular travel expenses. Transaction patterns 176 can include various types of patterns for one or more accounts, such as transaction pattern for wages, transaction pattern for vacation, transaction pattern for expense reports, transaction pattern for vendor purchases, transactions patterns for work hours provided by an employee associated with the account, or any other pattern, which can be generated based on all accounts 174 associated with a profile 180 of a particular type of worker.

The profile 180 can correspond to any profile for which transaction pattern 176 can be generated for various accounts 174. For instance, profile 180 can correspond to any group of accounts to discern transaction patterns 176 for that account group. Profile 180 can be a profile for a group of accounts 174 of a group of full-time hourly construction workers, a profile of part-time restaurant workers, a profile of a hospital management group workers, a profile of engineering workers within a single entity 112, a profile of engineering workers across a plurality of entities 112, a profile of nurses across different hospitals, a profile of temporary employees in data processing departments or any other profiles associated with any number of accounts 174. Once associated with profiles 180, accounts 174 can have their transactions be analyzed for anomalies based on the various transaction patterns 176 of different profiles 180 with which the account may be associated.

Metric 134 can include any metric, value or a determination that can be used for detecting anomalies or inconsistencies in transactions using transaction patterns 176. The metric 134 can indicate the level of risk or anomalous or suspicious behavior or pattern associated with an account 174. The metric 134 can indicate a level of suspicion or risk of fraud associated with the account 174. For instance, a metric 134 having a value that does not satisfy a threshold 142 of a transactions pattern 176 can indicate that there is level of risk, or suspicion of fraud or malicious activity present or detected. For instance, a metric 134 having a value that satisfies a threshold 142 of a transaction pattern 176 can indicate that there is no level of risk or suspicion of fraud or malicious activity present or detected.

The metric 134 can be a parameter having a value indicative of whether a particular one or more transactions associated with one or more accounts 174 conforms to the transaction pattern 176 (e.g., satisfies the thresholds 142 of the transaction patterns 176). Metric 134 can include values, such as between 0 and 100 that can be used to compare against a particular threshold 142 (e.g., value of 60) to determine if the metric 134 satisfies the threshold (e.g., by being less than or equal to the threshold or by exceeding the threshold). Metric 134 can be generated by the metrics generator 132 based on historical data types 172 for a given type of group of transactions (e.g., payroll transactions) associated with a particular profile 180 of accounts 174 (e.g., student accounts, professional accounts, full-time employee accounts or any other grouping or profile of accounts).

Threshold 142 can include any threshold or value indicative of a limit of the transaction pattern 176. Threshold 142 can include a value indicating a boundary between an expected, acceptable or normal transaction for a given account or a profile 180 of the account 174 and an anomalous or inconsistent transaction for that account or the profile 180 of the account 174. Threshold 142 can include a value or a parameter generated for any transaction pattern 176. When a transaction pattern 176 includes a function (e.g., a plurality of values organized as a function, such as on a plot or graph), the threshold 142 can include a value from a plurality of threshold values along the same transaction pattern 176. For instance, a threshold 142 can correspond to a particular range of transactions. For instance, a threshold 142 can change for a given account 174 over time, based on changes in the transaction patterns 176.

The threshold can be offset from a median, mean or average value of the transaction pattern 176 by any statistical range, such as 1, 1.3, 1.5, 1.8, 2.0, 2.2, 2.5, 2.7, 3.0 or more than 3 standard deviations or variances from the mean, median or average value. The threshold 142 can be adjusted, based on the value, importance, priority or weight of the transaction for which the detection or anomaly is detected. For instance, a first threshold 142 can be established for a transaction of a first type within a first range of resources 114 transacted and a second threshold 142 can be established for a transaction of a second type within a second range of resources 114 transacted. The first and the second thresholds can be a different number of standard deviations or variances offset from a mean, median or average value of the transaction pattern 176, based on the range of resources 114 being transacted.

Constraints 178 can include any limitation or constraint that may impact the determination of a compliance controller 150. For instance, constraints 178 can involve bars or limits that may affect the transaction patterns 176 with respect to the metric or the threshold 142. Constraints 178 can include limitations that can cause the compliance controller 150 to modify at least a metric 134 or a threshold 142. Constraint 178 can include for instance, a limitation on the amount of resources 114 (e.g., a number of days of vacation time or personal time off, a number of overtime hours or any other resources) that can be generated, provided, transacted or issued. Constraints 178 can be permanent or temporary, such as limited to a particular time interval (e.g., a month, a quarter or a year), and can be applied to one or more entities 112, departments or group of accounts 174 within an entity, or particular accounts or groups of accounts 174 of a same profile 180 across different entities 112 (e.g., to all engineering departments across a plurality of companies). A constraint 178 can include, for example, a limitation on the amount of vacation that can be granted to accounts 174 of a particular group (e.g., department of an entity 112) within a particular time frame (e.g., a month of July). For instance, a constraint 178 can limit the vacation days granted to 25% of the engineering department due to a project that is scheduled to be completed at the end of the month (e.g., July). Therefore, the constraint 178 can impact determinations made by the compliance controller 150 on a temporary basis (e.g., for the duration of the constraint) and for accounts associated with that particular profile 180.

The data collector 130 can receive or retrieve more than one data set 170 from a first source, such as the transactions processors 110. For example, the data collector 130 receives a first data set from the transactions processors 110 at a first time and a second data set from the transactions processors 110 at a second time. The data collector 130 receives, retrieves, or aggregates the data set 170 periodically (e.g., every minute, every week) responsive to a change or modification of the data set 170 by the source (e.g., the payroll processing system of the transactions processor 110), from a push or request from the source to collect the data set 170, by a request (e.g., as implemented by a client device 120), or by a push or a query from a subcomponent of the data processing system 105 (e.g., by the model trainer 160 instructing the data collector 130 to retrieve the data set 170). The data set 170 can be associated with a time stamp. The data collector 130 can receive the data as a data stream or real-time data feed.

Due to the large amount of data that can be collected, the data processing system 105 can use predictive analytics models (e.g., models 162) to improve the performance of data collecting or downstream processing by filtering out irrelevant data, or otherwise focusing the system on useful data. For instance, data processing system 105 can employ predictive analytics models trained on historical compensation data to forecast the quality of incoming data elements. These models can predict the accuracy and reliability of employee compensation information, such as salaries, benefits, and payroll deductions, based on past patterns and anomalies. The data processing system 105 can prioritize data with higher predicted quality scores for compensation planning to ensure accurate and fair remuneration practices.

The data processing system 105 can use natural language processing for environmental data quality. The data processing system can apply natural language processing (NLP) techniques to analyze textual data related to environmental and sustainability initiatives, such as identification, establishment and generation of transaction patterns 176. NLP algorithms can extract key insights and sentiment from unstructured data sources, facilitating prioritization of data elements that align with the transaction patterns 176 of a group of accounts 176. By leveraging NLP, the data processing system can discern transaction patterns 176 along with their corresponding tolerance range that can be indicated by thresholds 142 away from the median, average or expected transaction pattern 176. In doing so, the NLP or other machine learning models 162 can be trained to identify transaction patterns 176 for particular one or more accounts 174, such as a pattern for all of the accounts 174 of an entity or for one or more groups of accounts (e.g., accounts of departments within the entity).

The data processing system 105 can provide reinforcement learning for adaptive prioritization. The data processing system can implement reinforcement learning algorithms to dynamically adjust the prioritization of data elements based on feedback and outcomes. The data processing system 105 can learn from past decisions and their impact on compensation planning, continuously refining prioritization strategies to focus on data elements that contribute most to achieving sustainability targets. With reinforcement learning, the data processing system 105 can adaptively prioritize data elements essential for sustainable compensation practices. This allows the data processing system 105 to remains responsive to changing constraints 178 affecting determinations with respect to particular transaction patterns 176. For instance, a new information can indicate that a group of accounts 174 of a particular department cannot have more than a threshold percentage (e.g., 25%) of employees on vacation during a month in which a particular project is to be completed. In response to this new constraint 178, determinations involving metrics 134 for particular accounts 175 can be evaluated with modified thresholds 142 that can be changed or moved based on the constraint 178.

The data collector 130 synchronizes one or more subcomponents of the data set 170 using application programming interface (API) integration, Extract, Transform Load (ETL) Processes, or data replication and sync tools. The data collector 130 can perform pre-processing or data cleaning techniques to modify, clean, or otherwise prepare the data to improve the performance of other components of the data processing system 105 that utilize the data.

The data collector 130 and metrics generator 132 can address the technical challenge of determining a metric indicating an anomaly or inconsistency in the transaction patterns associated with one or more accounts 174 of one or more entities 112. The data collector 130 can aggregate and synchronize the data set 170 from transactions of various APFs 116 over time and use the collected data set 170 to identify and label (e.g., via metadata) historical data types 172 based on their types. Using the historical data types 172, the data collector 130 can generate training data sets for the model trainer 160 to utilize to train the AI models 162 to generate metrics 134 corresponding to accounts 174 that can be associated or linked with profiles 180 for which transaction patterns 176 are to be generated by the metrics generator 132. For example, the data collector 130 can acquire the data set 170 (e.g., data on salary, wages, bonuses, overtime pay, commissions, benefits and perks, payroll deductions, variable pay, payroll frequency, employee compensation, payroll expenses, employee demographics, compensation structure, benefit analysis, or turnover metrics, timecard data, punch-in clock timing data, employee access card information, employee online activity data describing online activities associated with the account, or any other data). The metrics generator 132 can utilize the data, along with AI models 162 to generate metrics 134 for various accounts 174. The metrics generator 132 can generate the metrics 134 for the accounts 174 according to transaction patterns 176 that can be associated with profiles 180 to which the accounts 174 may be linked (e.g., profile 180 of engineering department employees in a first entity 112, a profile 180 of management employees across various departments of an entity 112, or a profile of part-time employees across a plurality of entities 112). The metrics generator 132 can generate one or more metrics 134 for one or more accounts, based on the number of profiles 180 with which the account 174 is associated. By generating a plurality of transaction patterns 176 for a plurality of types of profiles 180 with which an account 174 can be linked or associated, the metrics generator 132 can improve the granularity of anomalies or inconsistencies that can be detected by the data processing system 102.

The metrics generator 132 can include any combination of hardware and software to determine one or more relationships among the data set 170. The metrics generator 132 can receive the data set 170 from the data collector 130 or the data repository 168. The metrics generator 132 can receive the data from the data collector 130 or the data repository 168 after the data has been synchronized. The metrics generator 132 can filter, curate, or scrub the data set 170. The metrics generator 132 can provide enhanced data privacy and security. The metrics generator 132 can remove, delete, or modify duplicate values or arrangements of the data set 170. Thus, the metrics generator 132 can improve the performance of components of the data processing system 105 that use the data by improving the quality of the data, thereby improving the reliability, accuracy or efficiency with which determinations are computed and actions 118 are taken.

The metrics generator 132 can use one or more models 162 to determine relationships within the data set 170. The models 162 can include models trained with machine learning using training. For example, the metrics generator 132 can determine, based at least on the first historical data type 172a (e.g., corresponding to transactions in which the entity 112 is transacting resources 114 to the account 174 or one or more accounts 174 corresponding to a particular individual or a user). For example, the metrics generator 132 can determine, based at least on the second historical data type 172b (e.g., corresponding to transactions or acts by the account 174 or an individual or user of the account 174 that can impact the transactions of resources 114 by the entity 112 to the account 174.

The data processing system 105 can include a threshold function 140 designed, constructed, and operational to implement an automated process to identify, generate or update a threshold value, or compare values of metrics with a threshold 142. The threshold function 140 can compare the first value of the metric 134 determined by the metrics generator 132 with a threshold 142. The threshold 142 can be a limit of an acceptable range of a transaction pattern 176 for one or more transactions processed by one or more APFs 116.

The data processing system 105 can include a metrics generator 132 designed, constructed, and operational to generate metrics 134. The metrics 134 can correspond to, or be indicative of, one or more transactions patterns 176. Metrics generator 132 can generate the metrics 134 using models 162, such as AI models 162 trained using various historical data (e.g., various data types 172). For instance, one or more models 162 can be trained using a first historical data type 172a that can be indicative of one or more first interactions of the one or more accounts 174 with a first computing system operating a first APF 116 (e.g., payroll processing transactions). The same one or more models 162 can be trained using a second historical data type 172 that can be indicative of one or more second interactions of the one or more accounts 174 with a second computing system operating a second APF 116 (e.g., transactions tracking involving employee movements, accessing of resources or assets or timing of entries). The metrics generator 132 can generate a value for a metric 134 corresponding to the account associated with a profile 180 to determine one or more relationships within the data set 170.

The compliance controller 150 can utilize a threshold function 140 to determine if the value of the metric 134 is within an expected range, such as a tolerance range of the transaction patterns 176 as indicated by the thresholds 142. When the compliance controller 150 determines that the metric does not satisfy (e.g., exceeds) the threshold 142 of the transaction pattern 176, the compliance controller 150 can determine the presence of the anomaly or inconsistency. In response to the determination of the anomaly or inconsistency, the compliance controller 150 can trigger or call for one or more actions 118 to be taken by APFs 116 at the transaction processor 110. For instance, the compliance controller 150 can determine the metric value for an account 174 and compare it with the transaction pattern 176 by using the threshold function 140. The threshold function 140 can compare the value of the metric 134 generated by the metrics generator 132 with an appropriate threshold 142. The appropriate thresholds 142 can be a particular threshold 142 selected from a plurality of thresholds 142 for a given transaction pattern 176, or for a given range or portion of a transaction pattern 176 appropriate for the given account 174 (e.g., based on a profile 180 or one or more constraints 178 that may apply to the account 174 with respect to a particular transaction pattern 176 or a portion or range of the transaction pattern function corresponding to the account 174).

The data processing system 105 can analyze, using the one or more models, the data indicative of energy consumption associated with the one or more locations of the entity or the data from the transactions processor 110 to determine an inconsistency or anomaly within the data. The inconsistency or anomaly can be determined based on a comparison of a metric indicative of a transaction pattern 176 with respect to an account 174 and any associated profiles 180 with which the account can be associated. The anomaly or inconsistency can correspond to an error, transactional mistake, an act of fraud or misinformation, a missing data value, or an outlier value that falls outside a nominal range. The data processing system 105 can utilize the models 162 to select an action 118 to be taken or implemented by the transaction processor 110 to address or remove the inconsistency from the data and modify the metric 134 or the threshold 142 (e.g., after the issue is addressed).

The data processing system 105 can utilize the compliance controller 150 to perform inconsistency or anomaly detections in the transactions. The data processing system 105 can use any anomaly detection techniques to identify unusual deviations from the transaction pattern 176, such as deviations by more than one or two standard deviations from the pattern. The data processing system 105 can use machine learning models 162 trained on historical data types 172 to automatically flag such anomalies for further investigation. Detecting anomalies with respect to transaction patterns allows the data processing system 105 to maintain data quality and reliability. By promptly identifying and addressing potential errors or irregularities, the data processing system 105 can generate and execute actions 118 that take corrective actions with respect via APFs 116 of the transactions processors 110.

The compliance controller 150 can determine, based on a comparison of the value of the metric 134 with a threshold 142, to command, trigger, call (e.g., via API call) or otherwise invoke an automated process (e.g., APF 116) via the payroll processing system (e.g., transactions processor 110). The command, call or invocation can include an instruction or a command 152 to modify at least one of the metric 134 or the threshold 142. The command 152 can include an instruction to address a process or a transaction that is anomalous or inconsistent, such as to recompute or adjust the given instruction. For instance, the compliance controller can trigger an API call to an APF 116 at the transactions processor 110 to recompute the transaction that exceeds the threshold 142 with respect to a transaction parameter 176. By recomputing, recalculating or otherwise adjusting this transaction, the metric 134 can be recomputed or adjusted (e.g., by metrics generator 132) to a value that satisfies the threshold.

The compliance controller 150 can select, using the one or more models 162, an action 118 to execute via the automated process (e.g., APF 116) that is configured to modify the metric or the threshold. The compliance controller 150 can include a selection function that selects the action 118 based on any combination of: a type of the threshold 142, a type of the metric 134, an account 174 associated with the metric 134, a profile 180 associated with the account 174 that is associated with the metric 134 or a type of a transaction that caused the metric 134 to not satisfy the threshold.

The compliance controller 150 can command, via the automated process, the payroll processing system to execute the action 118 to modify the metric 134 or the threshold 142. For instance, the compliance controller 150 can command (e.g., issue a command 152), via a transactions processor 110 or an APF 116, to execute an action 118 (e.g., a computation of a transaction of a particular APF 116). The new computation of the transaction can trigger the metrics generator 132 to readjust or recompute the metric 134, such that the metric 134 satisfies the threshold 142 (e.g., falls within the normal, approved or expected range of the transaction parameter 176). The compliance controller 150 can issue a command 152 to the APF 116 to adjust the metric 134 or adjust the threshold 142 (e.g., in view of a constraint 178).

The compliance controller 150 can select an action from the actions 180 data structure stored in data repository 168. Example actions 180 can include: i) adjust or recompute a payroll transaction for the account 174, such as a paycheck wage or salary transaction; ii) adjust or recompute a benefits transaction, such as a medical insurance or retirement account transaction; iii) an adjustment to a profile of an employee or group of employees; iv) an adjustment to a threshold 142 for a particular profile 180 or one or more accounts 174; v) an adjustment to a time entry for a project associated with the account; vi) an adjustment associated with a human resources or a payroll processing or a task, or any other process, transaction or operation associated with the entity 112, account 174 or profile 180.

The models 162 used by the compliance controller 150 to select or command the execution of the action 118 by APFs 116. The models 162 can be trained on historical data types 172 to predict how an action from the actions 180 data structure can impact the comparison of the metric 134 with thresholds 142 of the transaction patterns 176. Using the models 162, the compliance controller 150 can predict, identify, select, or otherwise generate an action 118 that is configured to adjust the metric 134 with respect to the threshold 142 or adjust the threshold 142 with respect to the metric 142.

Interface 154 can include any combination of hardware and software for interfacing between the data processing system 105, client devices 120 and transactions processors 110. Interface 154 can include hardware and software components for exchanging network data packets via network 101. Interface 154 can include applications with graphical user interfaces for allowing users of client devices 120 to gain access and utilize or operate any functionalities of the data processing system 105 or transactions processors 110. Interface 154 can be configured to transmit commands 152 from the data processing system 105 to the transactions processors 110 for triggering or commanding APFs 116 to implement desired or selected actions 118. Interface 154 can be configured to exchange data (e.g., data set 170) between the data processing system 105, transactions processors 110 or client devices 120.

The compliance controller 150 can utilize or operate a graphical user interface on which to display information. The compliance controller 150 can generate various dashboards for presentation or rendering via a graphical user interface by a client device 120. The compliance controller 150 can allow the client device 120 to trigger, operation or utilize any functionalities of the data processing system 105 or transactions processor 110 via a graphical user interface of the interface 154. The compliance controller 150 can utilize the interface 154 to illustrate transactions patterns 176 (e.g., functions or graphs or values) to the client device 120. The compliance controller 150 can illustrate or graph thresholds 142 and the metrics 134. The compliance controller 150 can utilize the interface 154 to display actions 118, adjustments to metrics 134 or adjustments to thresholds 142.

In some aspects, the models 162 (hereinafter referred to as model(s) 175, machine learning model(s) 175, trained model(s) 175, or retrained model(s) 175) include one or more neural networks, decision-making models, linear regression models, natural language models, random forests, classification models, reinforcement learning models, clustering models, neighbor models, decision trees, probabilistic models, classifier models, or other such models. For example, the models 162 include natural language processing (e.g., support vector machine (SVM), Bag of Words, Counter Vector, Word2Vec, k-nearest neighbors (KNN) classification, long short erm memory (LSTM)), object detection and image identification models (e.g., mask region-based convolutional neural network (R-CNN), CNN, single shot detector (SSD), deep learning CNN with Modified National Institute of Standards and Technology (MNIST), RNN based long short term memory (LSTM), Hidden Markov Models, You Only Look Once (YOLO), LayoutLM) (classification ad clustering models (e.g., random forest, XGBBoost, k-means clustering, DBScan, isolation forests, segmented regression, sum of subsets 0/1 Knapsack, Backtracking, Time series, transferable contextual bandit) or other models such as named entity recognition, term frequency-inverse document frequency (TF-IDF), stochastic gradient descent, Naïve Bayes Classifier, cosine similarity, multi-layer perceptron, sentence transformer, data parser, conditional random field model, Bidirectional Encoder Representations from Transformers (BERT), among others. It should be understood that this listing of machine learning models is exemplary and is not construed to be exhaustive or limiting.

The data processing system 105 includes a model trainer 160 designed, constructed, and operational to train, identify, or operate the models 162. The model trainer 160 trains the models 162 by receiving one or more of input from client devices 120, or the data set 170, among others. The model trainer 160 identifies models 162 for use by other subcomponents of the data processing system 105. The model trainer 160 stores or modifies the models 162 in the data repository 168.

To train the models 162, the model trainer 160 can use one or more of the data set 170, or one or more parameters correlated to the data set 170. The model trainer 160 uses the training data set constructed from data (e.g., historical data types 172) acquired from or associated with one or more client devices 120, transactions processors 110 or outputs from APFs 116. For example, the model trainer 160 trains the models 162 using the data set 170. The model trainer 160 can feed, supplement, or provide the input training data set as inputs to the models 162 to train the models 162. The inputs can include an input training data set that is based on known outputs of the input training data set. The input training data set can be annotated by a user of a client device 120 or otherwise have known outputs or incomes. By providing the input training data set with the inputs and known outputs to the models 162, the model trainer 160 generates the trained models 162. For example, the input training data set includes a large variety of data types, criteria, or parameters, among others. The input training data set can be marked to distinguish each attribute of the input training data set. The model trainer 160 generates the trained models 162 by providing the inputs to create the known outputs. This process can be iterative and can utilize any of the inputs or machine learning models described herein.

The model trainer 160 can validate the trained models 162 using a test data set. With generation of the models 162, the model trainer 160 provides inputs based on the test data set to determine a validity of each of the models 162. The validity of each of the models 162 can relate to an error. The error can be the difference between the known outcomes of the test data set and actual outcomes when inputs based on the test data set are provided to the models 162. For example, the test data set includes a known input and outcome. Upon providing the known input to a model 162 trained to accept that input, the model 162 provides the known outcome, or can provide a different, erroneous outcome. This comparison between the known outcome and the model-generated outcome can be repeated for various inputs of a model 162 to generate an overall error score or rate. The error score or rate can relate to the validity of the model 162. If the error score or rate for the model 162 exceeds a threshold error, the model 162 is considered invalid or erroneous. If the error score or rate for the model 162 is at or below the threshold error, the model 162 is considered valid. In this manner, each model 162 is validated.

The model trainer 160 retrains the models 162. The model trainer 160 can retrain the models 162 responsive to the error score of one of the models 162 being above a threshold error. In some cases, the model trainer 160 determines the error score of the models 162 is above the threshold error (e.g., invalid) responsive to generation of the models 162 by the model trainer 160. For example, the model trainer 160 determines that a model 162 of the models is invalid based on an error score of the model 162 exceeding an error threshold for the model 162 upon generation. The model trainer 160 determines that the models 162 are invalid prior to storing the models 162 in the data repository 168. The model trainer 160 can check the models 162 periodically to determine validity of the models 162. For example, model 162 which was once valid can drift, or become less valid or have a higher error score over time. The model trainer 160 checks the validity of the models 162 stored in the data repository 168, the models 162 generated by the model trainer 160, or the models of the system 100.

Upon the model trainer 160 determining that one or more models 162 are invalid, (e.g., the error score is above the threshold error), the model trainer 160 instructs the data collector 130, metrics generator 132, threshold function 140, compliance controller 150 to aggregate, collect, retrieve, or generate a second training data set. With receipt of the second training data set, the model trainer 160 retrains the models 162. The model trainer 160 divides the second training data set into subsets, such as a second training input data and a second test data. The model trainer 160 combines the training data set and the second training data set. For example, the model trainer 160 incorporates, combines, or adds the second training data to the training data. With the aggregation of the second training data set, the model trainer 160 provides further inputs and known outcomes to further train the models 162. The model trainer 160 retrains the models 162 with an error score above the threshold error, all of the models 162, or selected models 162. The model trainer 160 can retrain the models 162 or a subset of the models 162 subsequent to the elapse of a period of time. For example, the model trainer 160 retrains a model 162 every week, every year, or upon its error score not satisfying (e.g., exceeding) the threshold error for the model 162.

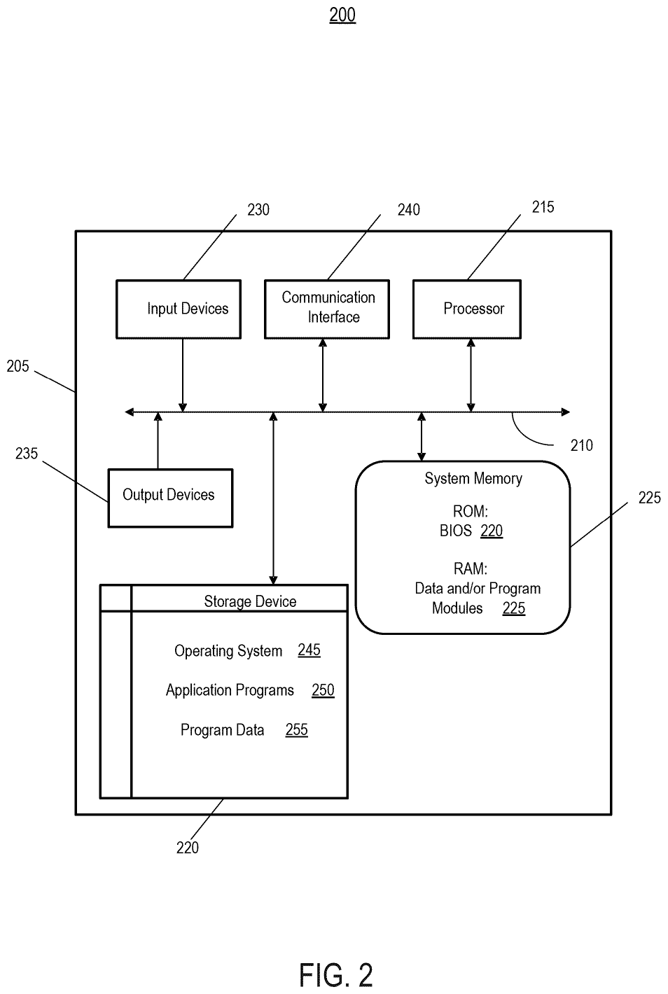

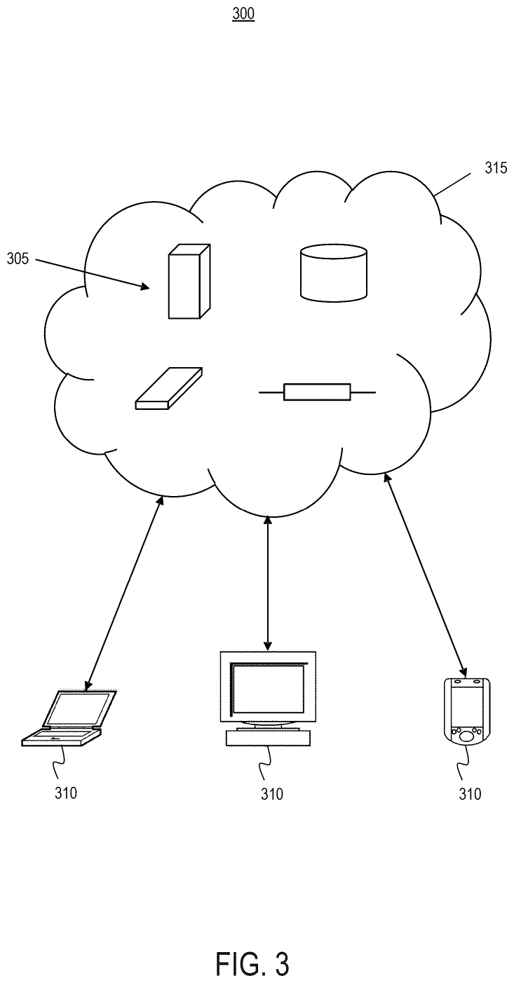

As shown in FIG. 2, computing system 200 includes a computing device 205. The computing device 205 can be resident on a network infrastructure such as within a cloud environment, as shown in FIG. 3, or can be a separate independent computing device (e.g., a computing device of a third-party service provider). The computing device 205 can include a bus 210, a processor 215, a storage device 220, a system memory (hardware device) 225, one or more input devices 230, one or more output devices 235, and a communication interface 240. One or more component of the computing system 200 can be part of or form the data processing system 105.

The bus 210 permits communication among the components of computing device 205. For example, bus 210 can be any of several types of bus structures including a memory bus or memory controller, a peripheral bus, and a local bus using any of a variety of bus architectures to provide one or more wired or wireless communication links or paths for transferring data and/or power to, from, or between various other components of computing device 205.

The processor 215 can be one or more processors or microprocessors that include any processing circuitry operative to interpret and execute computer readable program instructions, such as program instructions for controlling the operation and performance of one or more of the various other components of computing device 205. In embodiments, processor 215 interprets and executes the processes, steps, functions, and/or operations of the technical solutions described herein, which can be operatively implemented by the computer readable program instructions.

For example, processor 215 provides an enterprise-wide security approach with all stakeholders (e.g., Dev teams, leadership, CSO office, etc.) with a set of various anomaly detection and transaction (e.g., payroll processing) integrity functionalities into single tool. In embodiments, the processor 215 uniformly integrates or packages existing functions for anomaly detection (e.g., using AI or other features) into a transaction integrity tool that standardizes and visually displays the output over different development teams for any purposes of anomaly detection or transaction integrity. The integrated security tool can capture specific requirements of the different teams, i.e., ensures that the tools support varied team development methodologies and different tech stacks to capture required security vulnerabilities. The processor 215 also establishes a regular feedback mechanism and can be used to develop a process for remediation timelines and priority including at risk vulnerabilities.

In embodiments, processor 215 can receive input signals from one or more input devices 230 and/or drive output signals through one or more output devices 235. The input devices 230 can be, for example, a keyboard, touch sensitive user interface (UI), etc., as is known to those of skill in the art such that no further description is required for a complete understanding of the technical solutions described herein. The output devices 235 can be, for example, any display device, printer, etc., as is known to those of skill in the art such that no further description is required for a complete understanding of the technical solutions described herein.

The storage device 220 can include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 205 in accordance with the different aspects of the technical solutions described herein. In embodiments, storage device 220 can store operating system 245, application programs 250, and program data 255 in accordance with aspects of the technical solutions described herein.

The system memory 225 can include one or more storage mediums, including for example, non-transitory media such as flash memory, permanent memory such as read-only memory (“ROM”), semi-permanent memory such as random-access memory (“RAM”), any other suitable type of storage component, or any combination thereof. In some embodiments, an input/output system 220 (BIOS) including the basic routines that help to transfer information between the various other components of computing device 205, such as during start-up, can be stored in the ROM. Additionally, data and/or program modules 225, such as at least a portion of operating system 245, application programs 250, and/or program data 255, that are accessible to and/or presently being operated on by processor 215 can be contained in the RAM.

The communication interface 240 can include any transceiver-like mechanism (e.g., a network interface, a network adapter, a modem, or combinations thereof) that enables computing device 205 to communicate with remote devices or systems, such as a mobile device or other computing devices such as, for example, a server in a networked environment, e.g., cloud environment. For example, computing device 205 can be connected to remote devices or systems via one or more local area networks (LAN) and/or one or more wide area networks (WAN) using communication interface 240.

As discussed herein, computing system 200 can be configured to integrate different anomaly detection and transaction integrity features into a single workbench or tool. This allows developers and other team members a uniform approach to assessing security vulnerabilities throughout the enterprise. In particular, computing device 205 can perform tasks (e.g., process, steps, methods and/or functionality) in response to processor 215 executing program instructions contained in a computer readable medium, such as system memory 225. The program instructions can be read into system memory 225 from another computer readable medium, such as data storage device 220, or from another device via the communication interface 240 or server within or outside of a cloud environment. In embodiments, an operator can interact with computing device 205 via the one or more input devices 230 and/or the one or more output devices 235 to facilitate performance of the tasks and/or realize the end results of such tasks in accordance with aspects of the technical solutions described herein. In additional or alternative embodiments, hardwired circuitry can be used in place of or in combination with the program instructions to implement the tasks, e.g., steps, methods and/or functionality, consistent with the different aspects of the technical solutions described herein. Thus, the steps, methods and/or functionality described herein can be implemented in any combination of hardware circuitry and software.

FIG. 3 shows an exemplary cloud computing environment 300 in accordance with aspects of the technical solutions described herein. In embodiments, one or more aspects, functions and/or processes described herein can be performed and/or provided via cloud computing environment 300. As depicted in FIG. 3, cloud computing environment 300 includes cloud resources 305 that are made available to client devices 310 via a network 315, such as the Internet. Cloud resources 305 can be deployed or provided on a single network or a distributed network. Cloud resources 305 can be distributed across multiple cloud computing systems and/or individual network enabled computing devices. Cloud resources 305 can include a variety of hardware and/or software computing resources, such as servers, databases, storage, networks, applications, and platforms that perform the functions provided herein including storing code, anomaly detection and transaction integrity features or functionalities into a uniform and standardized application, e.g., display.

Client devices 310 can comprise any suitable type of network-enabled computing device, such as servers, desktop computers, laptop computers, handheld computers (e.g., smartphones, tablet computers), set top boxes, and network-enabled hard drives. Cloud resources 305 are typically provided and maintained by a service provider so that a client does not need to maintain resources on a local client device 310. In embodiments, cloud resources 305 can include one or more computing system 200 of FIG. 2 that is specifically adapted to perform one or more of the functions and/or processes described herein.

Cloud computing environment 300 can be configured such that cloud resources 305 provide computing resources to client devices 310 through a variety of service models, such as Software as a Service (SaaS), Platforms as a service (PaaS), Infrastructure as a Service (IaaS), and/or any other cloud service models. Cloud resources 305 can be configured, in some cases, to provide multiple service models to a client device 310. For example, cloud resources 305 can provide both SaaS and IaaS to a client device 310. Cloud resources 305 can be configured, in some cases, to provide different service models to different client devices 310. For example, cloud resources 305 can provide SaaS to a first client device 310 and PaaS to a second client device 310.

Cloud computing environment 300 can be configured such that cloud resources 305 provide computing resources to client devices 310 through a variety of deployment models, such as public, private, community, hybrid, and/or any other cloud deployment model. Cloud resources 305 can be configured, in some cases, to support multiple deployment models. For example, cloud resources 305 can provide one set of computing resources through a public deployment model and another set of computing resources through a private deployment model.

In embodiments, software and/or hardware that performs one or more of the aspects, functions and/or processes described herein can be accessed and/or utilized by a client (e.g., an enterprise or an end user) as one or more of a SaaS, PaaS and IaaS model in one or more of a private, community, public, and hybrid cloud. Moreover, although aspects of the technical solutions described herein include a description of cloud computing, the systems and methods described herein are not limited to cloud computing and instead can be implemented on any suitable computing environment.

Cloud resources 305 can be configured to provide a variety of functionality that involves user interaction. Accordingly, a user interface (UI) can be provided for communicating with cloud resources 305 and/or performing tasks associated with cloud resources 305. The UI can be accessed via a client device 310 in communication with cloud resources 305. The UI can be configured to operate in a variety of client modes, including a fat client mode, a thin client mode, or a hybrid client mode, depending on the storage and processing capabilities of cloud resources 305 and/or client device 310. Therefore, a UI can be implemented as a standalone application operating at the client device in some embodiments. In other embodiments, a web browser-based portal can be used to provide the UI. Any other configuration to access cloud resources 305 can also be used in various implementations.

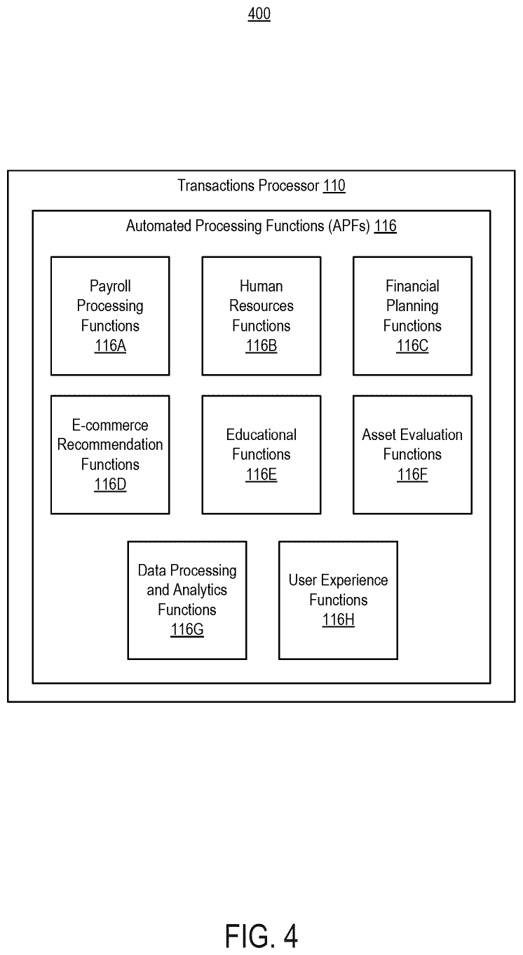

FIG. 4 illustrates an example of a transactions processor 110 providing a plurality of different automated processing functions (APFs) 116 for processing transactions and actions 118 commanded by the compliance controller 150. Transactions processor 110 can include any number of APFs 116, including a payroll processing function 116A, a human resources function 116B, a financial planning function 116C, an E-commerce recommendation function 116D, an educational function 116F, an asset evaluation function 116F, a data processing and analytics function 116, a user experience function 116G, or any other APFs 116.

The payroll processing function 116A can execute within the transactions processor 110 to automate the computations and management of resource 114 transactions with respect to accounts 174. For instance, the payroll processing function 116A can automate computation of paychecks or compensations to employees associated with employee accounts 174. The payroll processing function 116A can include tasks such as computing salaries, handling tax deductions, processing direct deposits, generating and distributing pay stubs, managing employee benefits, and ensuring compliance with payroll regulations. The payroll processing function 116A can facilitate the accuracy and efficiency in payroll operations, implementing the features of the compliance controller 150 (e.g., commands 152) to reduce computational effort and errors. For example, the payroll processing function 116A can handle monthly payroll cycles for employees across various departments, calculates overtime payments, health insurance benefits computations and manages statutory deductions like income tax and social security contributions.

The human resources function 116B can execute within the transactions processor 110 to automate the management of personnel-related transactions and actions 118 with respect to employee accounts 174. For instance, the human resources function 116B can automate employee onboarding and offboarding processes, manage attendance and leave records, conduct performance evaluations and appraisals, track training and development initiatives, maintain employee records securely, and generate compliance reports. The human resources function 116B can monitor movement or accessing of employees of particular files, facilities, labs or work sites, allowing tracking of efforts associated with an account 174. The human resources function can enhance HR efficiency by automating routine administrative tasks, leveraging the capabilities of the compliance controller 150 (e.g., commands 152) to streamline operations and improve employee management. For example, it can facilitate seamless onboarding for new hires, monitor employee attendance trends, assess performance metrics, and provide personalized development plans to enhance workforce productivity.

The financial planning functions 116C can include any function for providing financial planning for users (e.g., employees associated with accounts 174) based on the data sets 170 and the data associated with the account 174 or the profile 180. The financial planning functions 116C can be used with an AI-enabled personalized financial planning models (e.g., models 162 trained to provide financial planning based on the data set 170). The financial planning functions 116C can include a reporting system that leverages payroll and demographic data to provide individuals with financial forecasts and tailored recommendations for personal investments and financial plans.

The financial planning functions 116C can address the limitations of existing financial planning methods, by facilitating providing, allocating, transferring, assigning, transacting or otherwise managing any resources 114 with respect to any accounts 174 associated with entities 112. The financial planning functions 116C can generate suggestions or recommendations for investments or financial planning tasks or steps, based on the data of the account 174 or profile 180. Automated processing functions 116 can include, for example, any payroll transaction processing functions, such as functions for processing transactions for pay stubs, employee salaries, bonuses, or medical or other benefits. Automated processing functions 116 can include transactions for processing time entries, employee clock (e.g., start and stop work time), employee facility access card activity monitoring functions or any other functions associated with behavior or actions of users (e.g., employees) associated with the accounts 174 or profiles 180.

The financial planning function 116C can overcome the issue of a lack of personalized insights and that may fail to consider individual payroll and demographic data, leading to generic advice that may not align with users' specific financial circumstances. The financial planning solution 116C can incorporate AI algorithms effectively to predict and generate recommendations for financial plans and investments based on the data of the account 174. The financial planning function 116C can operate along with AI models 162 trained to provide personalized financial planning based on the payroll, HR processing or demographic data associated with the accounts 174.

The e-commerce recommendation function 116D can include any combination of hardware and software for providing AI-model based recommendations for e-commerce transactions. The e-commerce recommendation function 116D can leverage machine learning algorithms to analyze customer behavior and preferences, process transactional data and user interactions and generate personalized product recommendations tailored to individual customers. The e-commerce recommendation function 116D can generate the recommendations using the models 162 trained to recommend e-commerce transactions, based on the data of the account 174. These recommendations can be based on factors such as purchase history, browsing patterns, and demographic information, enhancing the shopping experience and increasing customer satisfaction. The e-commerce recommendation function 116D can continuously learn from new data to refine its recommendations, facilitating improvement to relevance and effectiveness in guiding purchasing decisions.

The educational function 116E can include any combination of hardware and software for generating educational content based on the data of the account 174. Educational function 116E can include, generate and provide a personalized learning platform designed to enhance educational experiences using AI models 162 trained to generate educational content, based on the payroll, HR or other data associated with the account 174. The educational function 116 can integrate machine learning algorithms to analyze user account related performance data and tailor educational content for the data of the account. By processing student interactions and academic progress, the function 116E delivers personalized recommendations and adaptive learning pathways, optimizing learning outcomes. This platform facilitates continuous improvement by adjusting content delivery based on individual learning pace and comprehension levels, determined from the data of the account 174 or profile 180 associated with the account 174, thereby improving the learning process.

The educational function 116E can be provided as a part of an AI model-based platform that utilizes advanced data analytics and machine learning algorithms to process payroll, demographic, and historical education data from data set 170 for each user or student. By analyzing historical data types 172 within accounts 174 and profiles 180, the platform can identify patterns, strengths, and areas for improvement, which can inform the creation of personalized learning content. Users can be presented with content generated by AI models 162 based on historical data associated with accounts and inferred interests, learning preferences, and potential career aspirations. This approach can determine or generate content based on transaction patterns 176 allowing users to progress at their own pace for a more engaging and efficient learning experience. The platform can adapt and improve based on real-time data feedback, incorporating students' progress, performance, and feedback to refine personalized learning paths and facilitate continuous adjustment and optimization.

The asset evaluation function 116F can include any combination of hardware and software to utilize data associated with accounts 174 and profiles 180 to evaluate value of resources 114 or assets. For instance, the asset evaluation function 116F can incorporate sophisticated valuation models and machine learning algorithms to assess the financial worth of diverse assets within accounts 174. Utilizing historical transaction data, the asset evaluation function 116F can determine or discern market trends (e.g., increasing or decreasing value of assets) from data set 170. The asset evaluation function 116F can analyze asset performance and market conditions to provide evaluations using AI models 162. By processing data types 172 and profiles 180, the function can provide determinations of any assets, such as pieces of art, real estate, personal property, business equipment, intellectual property, or any other type of property of an entity 112 or a user of the account 174.

The data processing and analytics function 116G can include any combination of hardware and software for processing and analyzing data associated with operations of entity 112. The data processing and analytics function 116G can integrate data processing techniques and analytics tools to analyze extensive datasets within data set 170. By leveraging machine learning algorithms and processing data types 172 across profiles 180 and accounts 174, the function can extract patterns of data transactions. The patterns can show trends and patterns associated with transactions. The data processing and analytics function 116G can allow entity 112 to make informed decisions by transforming raw data into actionable information, optimizing operational efficiency, and identifying opportunities for growth.

The user experience function 116H can include any combination of hardware and software to evaluate and determine levels of user experience based on the data associated with accounts 174 and profiles 180. The user experience function 116H can integrate AI models 162 to improve interactions across associated with accounts 174 and profiles 180. By leveraging data set 170 and analyzing user behaviors and preferences, the user experience function 116H can tailor interfaces and functionalities to improve usability and engagement. The user experience function 116H can utilize advanced UX/UI design methodologies to create intuitive and seamless experiences, improving satisfaction and retention.

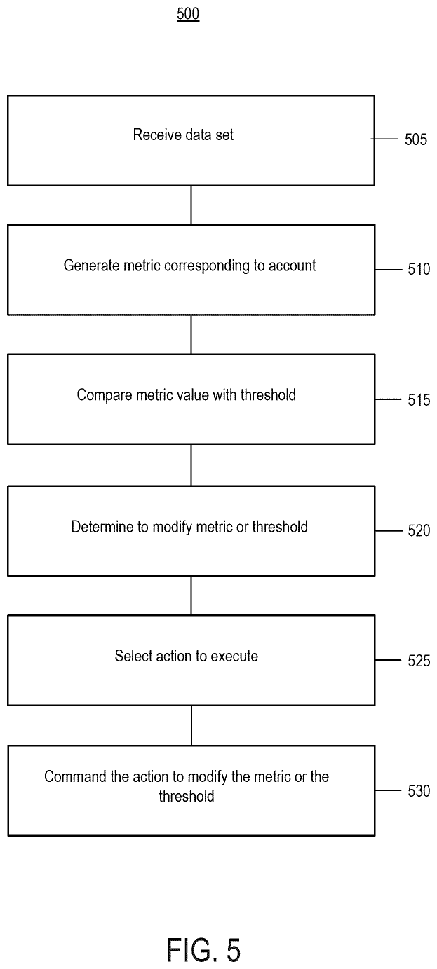

FIG. 5 depicts a method 500 for providing AI-based anomaly detection and selection of corrective actions to improve transaction integrity. The method 500 can be performed by one or more system or component depicted in FIGS. 1-4, including, for example, a data processing system 105 of FIG. 1 implemented on a computing system 200 of FIG. 2 or using a cloud computing environment 300 of FIG. 3. For instance, the method 500 can be implemented by one or more processors 215 executing operations based on instructions and data stored in a system memory 225, where the instructions can cause the one or more processors 215 to implement any functionality of the data processing system 105. The method 500 can include acts or operations 505-530. At 505, the data set can be received. At 510, a metric corresponding to an account can be generated. At 515, the metric can be compared with a threshold. At 520, a determination can be made to modify the metric or the threshold. At 525, an action can be selected to execute. At 530, a command for the action can be issued to modify the metric or the threshold.

At ACT 505, the method can include the data processing system receiving a data set. The method can include a processor receiving data for each of a plurality of profiles linked with one or more accounts of an entity. The data can be received from a payroll processing system, such as a transactions processor implementing an automated processing function for payroll transactions (e.g., a payroll processing function). The data can be indicative of a plurality of instances of first historical data (e.g., data corresponding to amount of resources the entity transacts to, for, or on behalf of an account) and second historical data (e.g., data corresponding to actions of a user associated with an account, where the data impacts transactions of the entity to, for, or behalf of the account). The first historical data can be indicative of one or more first interactions of the one or more accounts with a first computing system (e.g., payroll processing function) and the second historical data can be indicative of one or more second interactions of the one or more accounts with a second computing system (e.g., human resources functions, such as functions tracking time entries, purchases or expenses, or movement or access of employees associated with accounts).

The first interactions each include one or more parameters indicative of one or more corresponding payroll transactions executed by the entity on behalf of the one or more accounts. For instance, the first interactions can correspond to the first historical data type indicative of amounts of resources entity is to transact towards, or on behalf of, the account of a particular individual (e.g., employee). The second interactions each include one or more parameters indicative of one or more actions associated with the one or more accounts. The one or more actions of the second interactions can be actions impacting one or more payroll transactions indicated by parameters of the first interactions. The second interactions can correspond to a second historical data type corresponding to measurements, values or parameters indicative of activity or actions of the individual or user associated with the account, where the measurements, values or parameters impact or affect the number of resources the entity is to transact toward, or on behalf of, the account.

The data processing system can receive the data from various systems or components, including, for example, a transactions processor or any of its automated processing functions. The data set can be received from payroll processing functions, human resources functions, financial planning functions, e-commerce recommendations functions, educational functions, asset evaluation functions, data processing and analytics functions or user experience functions. The data processing system can receive various types of data. The data processing system can receive the data at various time intervals. For example, the data processing system can receive a data stream, such as a real-time data feed. In some cases, the data processing system can receive data based on a time interval, periodically (e.g., every one minute, hour, every 2-4 hours, or any other interval). In some cases, the data processing system can receive data responsive to a condition, event or trigger, such as generation of data of a particular type.

The data processing system can receive various types of data, including, for example, a first data type. The first data type can include any data on amounts or timing of transactions of resources by the entity that can be transacted to, for, or on behalf of, one or more accounts or users, or employees or individuals associated with the one or more accounts. The first data type can include one or more of: payroll data elements (e.g., salary, wages, bonuses, overtime pay, or commissions), benefits and perks (e.g., health insurance coverage, retirement contributions, stock options, or wellness program participation), payroll deductions (e.g., taxes (federal, state, local), social security contributions, Medicare contributions, or retirement plan contributions), variable pay (e.g., performance-based bonuses, profit-sharing distributions, or incentive compensation), payroll frequency (e.g., monthly, bi-weekly, or weekly). Data set can include demographic data (e.g., age, gender, marital status, family size, or educational level). The first data type can include one or more of: employee compensation (e.g., total payroll expenses, salary distributions, bonus allocations, or benefits contributions), payroll expenses (e.g., payroll taxes, social security contributions, or Medicare contributions), employee demographics (e.g., workforce composition by age, gender distribution, or educational background), compensation structure (e.g., compensation by job role, pay equity analysis, or variable pay distribution), benefits analysis (e.g., cost of employee benefits, utilization rates for health insurance, retirement plan participation), or turnover metrics (e.g., employee retention rates, reasons for turnover, or cost of employee turnover).

The data processing system can receive data corresponding to historical second data type, such as actions of users associated with accounts that can be used to determine resources transacted by the entity to the account. For instance, the historical second data type can include access card data indicating the timing of access of a facility or location by a user, timing of usage of resources (e.g., online or physical resources or features), time entries associated with efforts by a user of the account, expense reimbursements requested by the user of the account, vendor purchases made on behalf of the entity associated with the account, or any other actions or activities that can be used to determine the amount of resources transacted by the entity to the account, or on behalf of the account. The data set can be stored into a repository in one or more data structures or databases to be made available to various components of the data processing system.

At 510, the method can include the data processing system generating a metric corresponding to an account. The method can include the one or more processors generating a metric indicative of a pattern of transactions. The metric can correspond to an account of the entity linked to a profile. The one or more processors can generate the metric using one or more models trained with machine learning on the plurality of instances of the first historical data and the second historical data. The one or more processors can generate a value for the metric. The value of the metric can indicate the level, quantity or magnitude of the metric to be compared with a threshold for the metric at 515.

The metrics generator can generate a metric indicative of a transaction pattern for a profile associated with one or more accounts including the particular account for which the metric is generated. The metrics generator can generate the metric using an AI model trained using the first historical data and the second historical data. The metrics generator can generate the transaction pattern for one or more accounts (e.g., including the particular account associated with the metric) using the one or more AI models trained using the data set (e.g., historical data types including the first and the second historical data). The transaction pattern can identify a common or average pattern of transactions, including a transaction range or values that can be limited by thresholds associated with the transaction pattern. The thresholds can include the threshold to be compared with the metric.

The method can include the metrics generator generating one or more first features indicative of the one or more first interactions involving providing of resources of the entity to the account. The metrics generator can generate the metric using the one or more models receiving input including the one or more first features. The one or more first features can be generated based on the first historical data. For instance, the one or more first features can be generated based on payroll processing function processing payroll data, such as salary, wages, retirement account contributions or other data involving values or parameters indicative of transactions by the entity to the account associated with the metric.

The method can include the metrics generator generating one or more second features indicative of the one or more second interactions associated with information generated by a user associated with the account. The information can be used to provide a resource of the entity to the account. The metrics generator can generate the metric using the one or more models receiving input including the one or more second features. The one or more second features can be generated based on the second historical data. For instance, the one or more second features can be generated based on human resources function processing human resources transactions, such as transactions involving timestamps indicative of timing of access of a resource by a user associated with the account, transactions involving the account, resources claimed by the account (e.g., overtime amounts, vacation days), or any other data impacting or affecting the amount of resources transacted by the entity towards, on behalf of, or for the account associated with the metric.

At 515, the metric can be compared with a threshold. The method can include the one or more processors comparing a value of the metric with the threshold for the metric. For instance, a threshold function can compare a metric generated by the metrics generator with a threshold of a transaction pattern associated with a profile with which the account corresponding to the metric is associated. For instance, a profile can be a profile associated with one or more accounts, such as accounts of a particular department of a corporation, accounts of particular group of employees (e.g., part-time employees, seasonal employees, financial processing employees, management employees, security employees), or a profile associated with the account alone.

The threshold can indicate a limit between acceptable, normal or approved transaction pattern and suspicious, anomalous or fraudulent transaction pattern. There can be a plurality of thresholds for a plurality of portions of one or more transaction patterns. When the metric satisfies the threshold (e.g., the value of the metric falls within an approved range of the threshold), the account can be identified as normal (e.g., not anomalous). When the metric does not satisfy the threshold (e.g., the value of the metric falls outside of the approved range of the threshold), the account can be identified as anomalous, potentially risky or high risk, or potentially fraudulent.

The method can include the one or more processors identifying that the account corresponds to a group of accounts associated with a constraint for the pattern of transactions. For instance, the constraint can include a limitation to a threshold for the transaction pattern. The constraint can correspond, for example, to a limitation to the number of employees that can be granted a vacation within a particular month, a limitation on the number or amount of overtime that an employee can claim during a particular time period, a limitation on the amount of contributions that an employee can invest in a retirement account. In response to detecting the constraint, the one or more processors can determine that the threshold does not satisfy the constraint for the group of accounts (e.g., the profile). In response to detecting the constraint, the one or more processors can determine that the threshold satisfies the constraint for the group of accounts. Depending on whether the constraint is satisfied, the one or more processors may take different actions (e.g., corrective actions using automated processing functions) to satisfy or enforce the constraint (e.g., at acts 520 or 525).

At 520, the method can determine to modify the metric or the threshold. The method can include the one or more processors determining to call (e.g., via API call), trigger, utilize or invoke an automated process via the payroll processing system (e.g., transactions processor) to modify at least one of the metric or the threshold. The one or more processors can determine to invoke one or more automated processing functions of the transactions processors in order to address, recompute or adjust one or more transactions that impact the metric or the threshold. For instance, one or more automated processing functions (e.g., functions processing payroll computations, human resource computations or any other processes of the transactions processor) can impact, modify, adjust or otherwise change at least one of the values of the metric of the account or the threshold with which the metric is compared.

The automated process that can be called, triggered, utilized or invoked can correspond to a notification from the payroll processing system, such as a transactions processor. The automated process that can be called, triggered, utilized or invoked can correspond to a restriction on communication with the first computing system, such as an automated processing function processing transactions in which the entity transacts resources towards, for, or on behalf of, the account associated with the metric. The automated process that can be called, triggered, utilized or invoked can correspond to a restriction on communication with the second computing system, such as an automated processing function processing transactions involving parameters or values generated by an individual associated with the account, where the values or parameters can affect, impact or change the amount of resources transacted by the entity towards, for, on behalf of, the account associated with the metric. The action determined to be called, invoked or utilized can correspond to detection of a difference between interactions linked with the profile at the payroll processing system and interactions linked with the profile at the first computing system or the second computing system.

At 525, the method can select an action to execute. The method can include the one or more processors selecting, using the one or more models, an action to execute via the automated process. The action can be an action configured to modify, impact, affect or change at least one of the metric or the threshold (e.g., the metric, the threshold or both the metric and the threshold). The action can be a function processing one or more payroll transactions, one or more human resources transactions, or any other automated processing function. The compliance controller can select the action from a plurality of actions, based on any one or more of: the value of the metric, the type of the profile, the type of the account or the transaction pattern of the threshold.

The method can include the compliance controller identifying that the account corresponds to a group of accounts associated with a constraint for the pattern of transactions. The compliance controller can determine, using the threshold function, that the threshold does not satisfy the constraint for the group of accounts. The constraint can be a constraint associated with a particular transaction pattern, policy or one or more rules for the profile or the account. The compliance controller can determine that the constraint does not satisfy the threshold, in response to determining that the constraint corresponds to a threshold pattern corresponding to the threshold. The compliance controller can select the action based on the threshold not satisfying the constraint. The action can impact, modify, adjust or result in a change to the threshold, such as a threshold with respect to the profile.

The method can include the compliance controller identifying that the account corresponds to a group of accounts associated with a constraint for the pattern of transactions and determine, using the threshold function, that the threshold satisfies the constraint for the group of accounts. The compliance controller can determine that the constraint satisfies the threshold, in response to determining that the constraint corresponds to a threshold pattern corresponding to the threshold. Based on the threshold satisfying the constraint, the compliance controller can select the action. The action can impact, modify, adjust or result in a change to the metric, such as a metric with respect to the account.

At 530, the method can include issuing, generating or transmitting a command for the action to modify the metric or the threshold. The method can include the one or more processors commanding, via the automated process (e.g., a transactions processor), the payroll processing system to execute the action to modify the metric or the threshold. The method can include the compliance controller generating the command to implement or execute the action selected at act or operation 525. The command can include an API call to a transactions processor for one or more automated processing functions. The command can include a command or an instruction to recompute, adjust or otherwise reassess a computation of the automated processing function that has caused the value of the metric to not satisfy the threshold.

For instance, the compliance controller can command, via the automated process (e.g., transactions processor), the payroll processing system to execute the action. The compliance controller can command, via the automated process, a second action to modify one or more operations of the first computing system with respect to the profile. The compliance controller can command, via the automated process, the payroll processing system to execute a third action to modify one or more operations of the second computing system with respect to the profile.

The foregoing examples have been provided merely for the purpose of explanation and are in no way to be construed as limiting of the present description. While aspects of the technical solutions described herein have been described with reference to an exemplary embodiment, it is understood that the words which have been used herein are words of description and illustration, rather than words of limitation. Changes can be made, within the purview of the appended claims, as presently stated and as amended, without departing from the scope and spirit of the technical solutions described herein in their aspects. Although aspects of the technical solutions have been described herein with reference to particular means, materials and embodiments, the present description is not intended to be limited to the particulars described herein; rather, the technical solutions described herein extend to all functionally equivalent structures, methods and uses, such as are within the scope of the appended claims.

Although an example computing system has been described in FIG. 9, the subject matter including the operations described in this specification can be implemented in other types of digital electronic circuitry, or in computer software, firmware, or hardware, including the structures described in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures described in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently described systems or methods, their components, acts, or elements to single or plural configurations. References to any act or element being based on any information, act or element may include implementations where the act or element is based at least in part on any information, act, or element.

Any implementation described herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations described herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the described elements and operations without departing from the scope of the technical solutions described herein.

References to “approximately,” “substantially”, or other terms of degree include variations of +/−10% from the given measurement, unit, or range unless explicitly indicated otherwise. Coupled elements can be electrically, mechanically, or physically coupled with one another directly or with intervening elements. Scope of the Systems and methods described herein is thus indicated by the appended claims, rather than the foregoing description, and changes that come within the meaning and range of equivalency of the claims are embraced therein.

What is claimed is:

1. A system, comprising:
one or more processors, coupled with memory, to:
receive, from a payroll processing system, data for each of a plurality of profiles linked with one or more accounts of an entity, the data indicative of a plurality of instances of first historical data and second historical data, the first historical data indicative of one or more first interactions of the one or more accounts with a first computing system and the second historical data indicative of one or more second interactions of the one or more accounts with a second computing system;
generate, using one or more models trained with machine learning on the plurality of instances of the first historical data and the second historical data, a metric indicative of a pattern of transactions, the metric corresponding to an account of the entity linked to a profile;
determine, based on a comparison of a value of the metric with a threshold, to invoke an automated process via the payroll processing system to modify at least one of the metric or the threshold;
select, using the one or more models, an action to execute via the automated process that is configured to modify the metric or the threshold; and
command, via the automated process, the payroll processing system to execute the action to modify the metric or the threshold.

2. The system of claim 1, comprising the one or more processors to:
identify that the account corresponds to a group of accounts associated with a constraint for the pattern of transactions;
determine that the threshold does not satisfy the constraint for the group of accounts; and
select, based on the threshold not satisfying the constraint, the action to modify the threshold.

3. The system of claim 1, comprising the one or more processors to:
identify that the account corresponds to a group of accounts associated with a constraint for the pattern of transactions;
determine that the threshold satisfies the constraint for the group of accounts; and
select, based on the threshold satisfying the constraint, the action to modify the metric.

4. The system of claim 1, comprising the one or more processors to:
generate, based on the first historical data, one or more first features indicative of the one or more first interactions involving providing of resources of the entity to the account; and
generate, using the one or more models receiving input including the one or more first features, the metric.

5. The system of claim 4, comprising the one or more processors to:
generate, based on the second historical data, one or more second features indicative of the one or more second interactions associated with information generated by a user associated with the account, the information used to provide a resource of the entity to the account; and
generate, using the one or more models receiving input including the one or more second features, the metric.

6. The system of claim 1, comprising the one or more processors to:
command, via the automated process, the payroll processing system to execute a second action to modify one or more operations of the first computing system with respect to the profile.

7. The system of claim 6, comprising the one or more processors to:
command, via the automated process, the payroll processing system to execute a third action to modify one or more operations of the second computing system with respect to the profile.

8. The system of claim 1, wherein the first interactions each include one or more parameters indicative of one or more corresponding payroll transactions executed by the entity on behalf of the one or more accounts.

9. The system of claim 1, wherein the second interactions each include one or more parameters indicative of one or more actions associated with the one or more accounts, the one or more actions impacting one or more payroll transactions indicated by parameters of the first interactions.

10. The system of claim 1, wherein the automated process corresponds to at least one of a notification from the payroll processing system, a restriction on communication with the first computing system, or a restriction on communication with the second computing system.

11. The system of claim 1, wherein the action corresponds to detection of a difference between interactions linked with the profile at the payroll processing system and interactions linked with the profile at the first computing system or the second computing system.

12. A method, comprising:
receiving, by a processor from a payroll processing system, data for each of a plurality of profiles linked with one or more accounts of an entity, the data indicative of a plurality of instances of first historical data and second historical data, the first historical data indicative of one or more first interactions of the one or more accounts with a first computing system and the second historical data indicative of one or more second interactions of the one or more accounts with a second computing system;
generating, by the processor using one or more models trained with machine learning on the plurality of instances of the first historical data and the second historical data, a metric indicative of a pattern of transactions, the metric corresponding to an account of the entity linked to a profile;
determining, by the processor and based on a comparison of a value of the metric with a threshold, to invoke an automated process via the payroll processing system to modify at least one of the metric or the threshold;
selecting, by the processor using the one or more models, an action to execute via the automated process that is configured to modify the metric or the threshold; and
commanding, by the processor via the automated process, the payroll processing system to execute the action to modify the metric or the threshold.

13. The method of claim 12, comprising:
identifying, by the processor, that the account corresponds to a group of accounts associated with a constraint for the pattern of transactions;
determining, by the processor, that the threshold does not satisfy the constraint for the group of accounts; and
selecting, based on the threshold not satisfying the constraint, the action to modify the threshold with respect to the profile.

14. The method of claim 12, comprising:
identifying, by the processor, that the account corresponds to a group of accounts associated with a constraint for the pattern of transactions;
determining, by the processor, that the threshold satisfies the constraint for the group of accounts; and
selecting, by the processor, based on the threshold satisfying the constraint, the action to modify the metric with respect to the profile.

15. The method of claim 12, further comprising:
generating, by the processor and based on the first historical data, one or more first features indicative of the one or more first interactions; and
generating, by the processor using the one or more models receiving input including the one or more first features, the metric.

16. The method of claim 15, further comprising:
generating, by the processor and based on the second historical data, one or more second features indicative of the one or more second interactions; and
generating, by the processor using the one or more models receiving input including the one or more second features, the metric.

17. The method of claim 12, further comprising:
commanding, by the processor via the automated process, the payroll processing system to execute a second action to modify one or more operations of the first computing system with respect to the profile.

18. The method of claim 17, further comprising:
commanding, by the processor via the automated process, the payroll processing system to execute a third action to modify one or more operations of the second computing system with respect to the profile.

19. The method of claim 12, wherein the first interactions each include one or more parameters indicative of one or more corresponding payroll transactions linked with the profile.

20. A non-transitory computer readable medium including one or more instructions stored thereon and executable by a processor to:
receive, by a processor from a payroll processing system, data for each of a plurality of profiles linked with one or more accounts of an entity, the data indicative of a plurality of instances of first historical data and second historical data, the first historical data indicative of one or more first interactions of the one or more accounts with a first computing system and the second historical data indicative of one or more second interactions of the one or more accounts with a second computing system;
generate, by the processor using one or more models trained with machine learning on the plurality of instances of the first historical data and the second historical data, a metric indicative of a pattern of transactions, the metric corresponding to an account of the entity linked to a profile;
determine, by the processor and based on a comparison of a value of the metric with a threshold associated with the profile, to invoke an automated process via the payroll processing system to modify the metric;
select, by the processor using the one or more models, an action to execute via the automated process that is configured to modify the metric; and
command, by the processor via the automated process, the payroll processing system to execute the action to modify the metric with respect to the account.
